(19) United States
(12) Patent Application Publication
(10) Pub. No.: US 2011/0250406 A1
(43) Pub. Date: Oct. 13, 2011

(54) ENHANCED MAGNETIC DIPOLE TRANSITIONS IN LANTHANIDE MATERIALS FOR OPTICS AND PHOTONICS

(76) Inventor: Rashid Zia, Providence, RI (US)

(21) Appl. No.: 12/998,599

(22) PCT Filed: Nov. 9, 2009
(86) PCT No.: PCT/US2009/006055

§ 371 Date: May 6, 2011

Related U.S. Application Data
(62) Division of application No. 61/198,719, filed on Nov. 7, 2008.

(51) Int. Cl. B32B 7/02; B32B 3/00; B32B 1/00; C09K 11/77; C09K 11/06

(52) U.S. Cl. 428/174; 252/301.4 R; 252/301.33; 428/212; 428/156

(57) ABSTRACT

An optically active material contains a mixture of Lanthanide ions and an optical scattering agent, where the optical scattering agent is selected to enhance magnetic dipole transitions from Lanthanide ions so as to modify emission spectra and/or tune the composite's effective permeability and permittivity.

### TECHNICAL FIELD

The teachings in accordance with the exemplary embodiments of this invention relate generally to optically active materials and devices and, more specifically, relate to lanthanide-based optically active materials and applications thereof.

### BACKGROUND

The development of high-fidelity single-photon sources represents the successful combination of two research directions both enabled by advances in nanofabrication: (1) quantum dot emitters in which semiconductor materials are molded into nanoscale forms that mimic microscopic atomic systems, and (2) high quality factor optical microcavities which modify microscopic light-matter interactions by structuring the local optical environment.

Over the past decade, nanoscale fabrication has also enabled developments in the field of optical meta-materials. Much like nanoscale quantum dots act as artificial atoms, researchers have shown that subwavelength metallic structures can act as optical “meta-atoms”. By superimposing the high frequency electric and magnetic resonances of these metallic meta-atoms, researchers have been able to engineer the permittivity and permeability of meta-materials. This has allowed for the development of negative index meta-materials in which simultaneously negative permittivity and permeability enable remarkable optical phenomena such as negative refraction, sub-diffraction limited imaging and even monochromatic invisibility cloaking. Thus, recent work has expanded both the range of optical materials and optical phenomena available for future photonic devices. As a field though, most research in optical metamaterials has focused upon eliciting high frequency, artificial magnetic resonances from macroscopic structures.

Metamaterials and Artificial Magnetic Resonances

The optical properties of man-made metamaterials, like those of their natural counterparts, are defined by the underlying electromagnetic resonances of their subwavelength constituents. Unlike natural materials though, most metamaterials to date have leveraged the magnetic resonances supported by metallic split-ring resonators, paired metal rods, and patterned metal-dielectric thin films.

Reference in this regard may be made to FIG. 1, which shows metamaterial designs incorporating artificial magnetic response of metallic nanostructures. In particular, FIG. 1(a) shows a double split-ring resonator from T. J. Yen et al. Science 303, 1494-1496 (2004); FIG. 1(b) shows paired metallic strips from F. Garwe et al. Appl. Phys. B 84, 139-148, (2006); and FIG. 1(c) shows a patterned metal-dielectric thin film from S. Zhang et al. Phys. Rev. Lett. 95, 137404 (2005).

Such metallic structures support geometric resonances which mimic the magnetic dipole response of an oscillating current loop. Superimposing the resonances of many such artificial magnetic dipoles, one can tune a metamaterial's effective permeability. Similarly, other metallic structures, such as unpaired rods or strips which mimic the response of a dilute plasma, can be incorporated to tune effective permittivity.

Metamaterials based upon metallic nanostructures have proven successful. Experimental reports have confirmed negative indices from the microwave regime down to the near-infrared portion of the electromagnetic spectrum, and significant magnetic response has also been demonstrated in the visible regime. However, the artificial magnetic resonances of metallic structures suffer from three major limitations. First, shaped geometric resonances do not easily scale into the visible regime, where fabrication limits make it exceedingly difficult to define subwavelength features. Second, in the visible regime, material losses in most metals severely limit both the quality factor of magnetic resonances and the propagation length of light through metallo-dielectric composites. Third, the inherent asymmetries of shaped metallic structures result in anisotropic material response which places severe limits on fabrication precision and device design.

These limitations have led researchers to explore alternative resonant systems for metamaterial design. In order to avoid the losses of metallic systems, some researchers have investigated the electromagnetic resonances supported by dielectric structures. For example, high permittivity rods and spheres support Mie-like electric and magnetic dipole scattering resonances; thus, assemblies of such structures can be used to realize negative index metamaterials.

Reference in this regard may be made to FIG. 2, which illustrates metamaterial design based upon scattering resonances of high index silicon carbide rods, from J. A. Schuller, R. Zia et al. Phys. Rev. Lett. 99, 107401 (2007). However, the lack of high index materials in the optical regime currently limits such dielectric metamaterials to the microwave and infrared regime.

Metamaterials and Natural Magnetic Dipole Transitions

Recently, research has begun to suggest a different approach for designing and characterizing optical metamaterials. Rather than shaping macroscopic materials to create artificial magnetic resonances, this research suggests that one may leverage the atomic magnetic dipole resonances to achieve the same effect. At its core, this research challenges a standard misconception regarding optical frequency magnetic activity.

In the literature, it is common for authors to contrast the strength of electric and magnetic dipole transitions at optical frequency. The argument is often made by comparing an approximate electric dipole ea₀ (where e is the electron charge and a₀ is the Bohr radius) and Bohr magneton μ_{B}=eh/2mₑc=αea₀/2 (where mₑ is the electron mass and α is the fine-structure constant). Note that the Bohr magneton is smaller than the approximate electric dipole by a factor of half the fine-structure constant α, which is approximately 1/137. As the transition probability depends upon the square of the matrix element, it would appear that the magnetic dipole transitions would be roughly 10⁵ smaller than electric dipole transitions.

However, the precise quantum mechanical transition probabilities strongly depend upon the specific electronic structure. In systems such as Lanthanide ions where the electric dipole transitions are weak or non-allowed, magnetic dipole transitions can be significant. For example, magnetic dipole transitions can mediate up to 33% of light from the 1.54 micron line of Erbium-doped fiber amplifiers. Noting this fact, it has been suggested that such natural magnetic dipole transitions could be used to realize a quantum negative index material.

Reference in this regard can be made to FIG. 3, which depicts a negative index response from Erbium-doped crystal, from Q. Thommen & P. Mandel, Opt. Lett. 31, 1803-1805 (2006). The dashed lines indicate the macroscopic permittivity and permeability from superimposed free ion response; solid lines indicate the response in a weak 7.1 mT static magnetic field. The degenerate electric and magnetic dipole transitions of the 1.54 μm Er³⁺:⁴I_{15/2}→⁴I_{13/2} are split by the weak field to tune the negative index response (marked by the gray shaded region).

### SUMMARY

In one aspect thereof the exemplary embodiments of this invention provide an optically active material that comprises a mixture of Lanthanide ions and an optical scattering agent, where the optical scattering agent is selected to interact with the Lanthanide ions so as to enhance magnetic dipole transitions (e.g. the ⁵D₀→⁷F₁ transition in Eu³⁺) while simultaneously enhancing or suppressing electric dipole transitions (e.g. the ⁵D₀→⁷F₀ transition in Eu³⁺). For metamaterials, this aids in engineering the effective permeability and permittivity of the composite. For luminescent applications, such effects specifically change the color distribution and enhance the quantum efficiency of Lanthanide emitters.

### BRIEF DESCRIPTION OF THE DRAWINGS

The foregoing and other aspects of the teachings of this invention are made more evident in the following Detailed Description, when read in conjunction with the attached Drawing Figures, wherein:

FIG. 1 shows meta-material designs incorporating artificial magnetic response of metallic nanostructures. In particular, FIG. 1(a) shows a double split-ring resonator from T. J. Yen et al. Science 303, 1494-1496 (2004); FIG. 1(b) shows paired metallic strips from F. Garwe et al. Appl. Phys. B 84, 139-148, (2006); and FIG. 1(c) shows a patterned metal-dielectric thin film from S. Zhang et al. Phys. Rev. Lett. 95, 137404 (2005).

FIG. 2 illustrates meta-material design based upon scattering resonances of high index silicon carbide rods, from J. A. Schuller, R. Zia et al. Phys. Rev. Lett. 99, 107401 (2007).

FIG. 3 depicts a negative index response from Erbium-doped crystal, from Q. Thommen & P. Mandel, Opt. Lett. 31, 1803-1805 (2006).

FIG. 4 depicts Lanthanide magnetic dipole transitions in the visible and near-infrared regime.

FIG. 5 is an energy level diagram for Eu³⁺ that highlights the optical transitions between the ⁵D_{J} and ⁷F_{J} states.

FIG. 6(a) shows calculated, and FIG. 6(b) shows observed emission enhancement for Eu³⁺ emitters above an extended gold film.

FIG. 7(a) compares the decay rates for magnetic and electric dipoles as a function of distance and dipole orientation from a 10 nm diameter gold particle, while FIG. 7(b) shows the emission spectra and time-resolved photoluminescence for a Europium chelate with and without gold nanoparticles.

FIG. 8 shows near-field experiments demonstrating modified electric dipole emission near a single gold nanoparticle, from P. Anger et al., Phys. Rev. Lett. 96, 113002 (2006).

FIG. 9 shows a scanning confocal and near field-microscope system that includes a nano precision X-Y-Z piezo stage; an imaging spectrograph incorporated with a photo multiplier tube and a multichannel analyzer for time-resolved measurements; and integrated graphical user interface (GUI) controls from a computer.

FIG. 10 shows an embodiment of a polarization-specific detection scheme designed to quantify the relative contributions of magnetic and electric dipole emission.

FIG. 11 depicts integrating atomic and artificial magnetic resonances, where FIG. 11(a) shows PMMA doped with Europium chelates as a spacer layer between paired metallic plates, while FIG. 11(b) shows Lanthanide phosphors dispersed on top of patterned split-ring resonators. FIGS. 11(c) and 11(d) show emission spectra of Europium doped phosphors dispersed in PMMA.

FIG. 12 illustrates a strong magnetic dipole enhancement by a random assembly of TiO₂ nanoparticles in accordance with an aspect of this invention.

FIG. 13(a) shows a schematic of photon-scanning tunneling microscope (PSTM) used to characterize surface plasmon waveguides and FIG. 13(b) shows an experimental near-field image from R. Zia et al., Nature Nanotech. 2, 426-429 (2007).

FIG. 14 illustrates a magnifying optical hyperlens, from Z. Liu et al. Science, 315, 1686 (2007), where FIG. 14(a) shows simulations and FIG. 14(b) experimental images demonstrating subdiffraction resolution with a multilayer metallo-dielectric metamaterial.

FIG. 15 shows a schematic of a metamaterial-enabled laser from N. I. Zheludev et al. Nature Photon. 2, 351 (2008).

FIG. 16, similar in some respects to FIG. 6(a), shows the relative optical enhancement of the radiative decay rates for the ₅D₀→⁷F₁ and ⁵D₀→⁷F₂ transitions of a Eu³⁺ ion located a finite distance from an Ag film.

FIG. 17 shows radiative decay rates near a gold nanoparticle for different dipole orientations, where FIG. 17(a) shows the normalized radiative decay rates for an electric dipole emitter as a function of distance and dipole orientation from a 10 nm diameter Au particle, and FIG. 17(b) compares the decay rates for magnetic and electric dipoles of a given orientation.

FIG. 18 shows an enlarged cross-sectional view of a multi-layered structure comprised of alternating rare earth phosphor and scattering nanoparticle containing layers and dielectric layers.

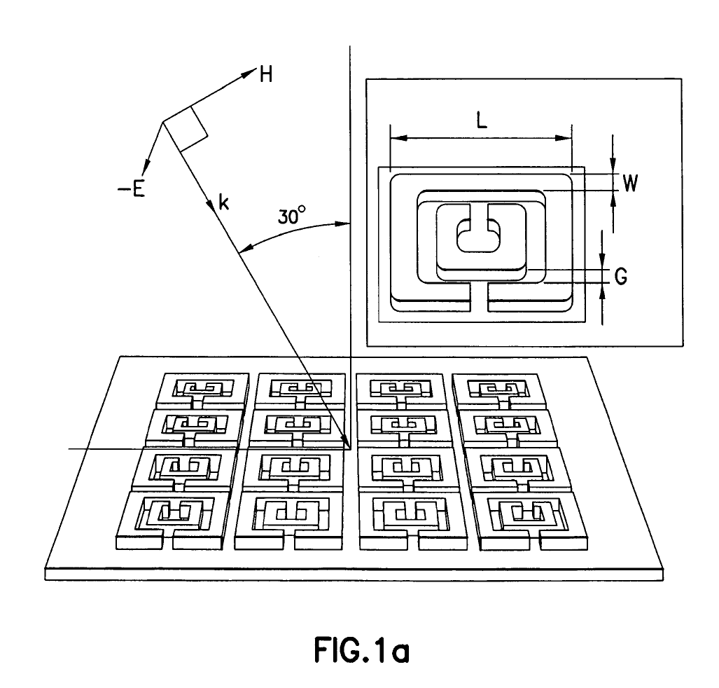

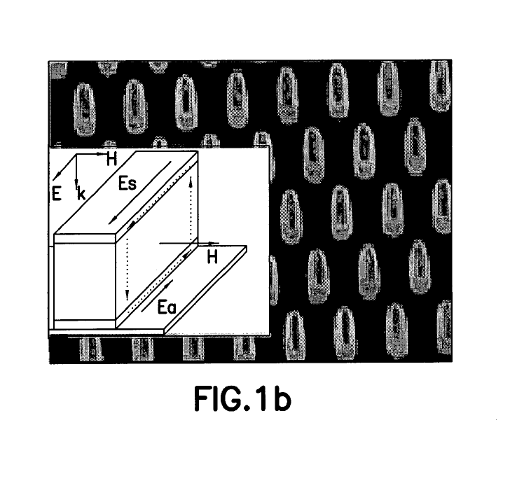

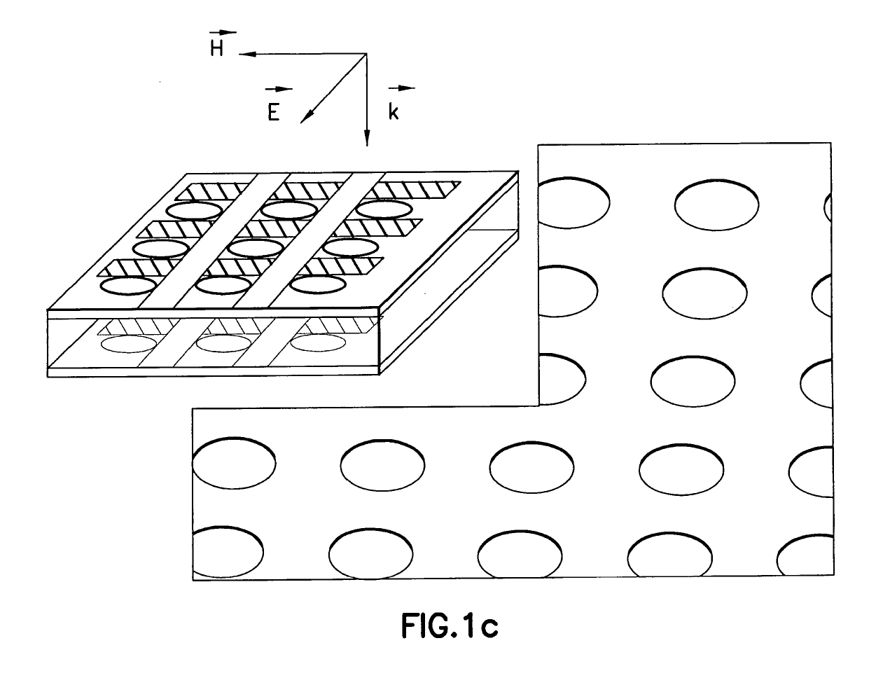

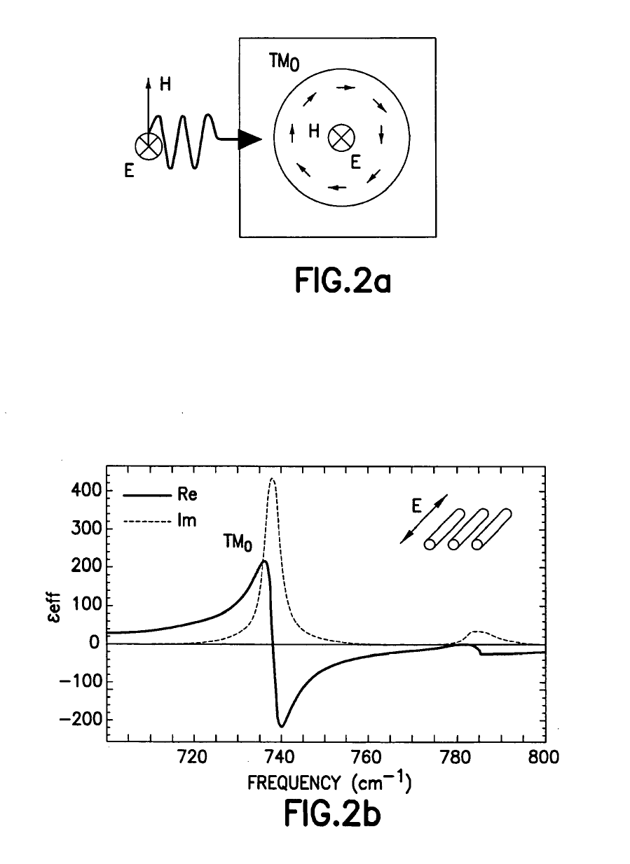

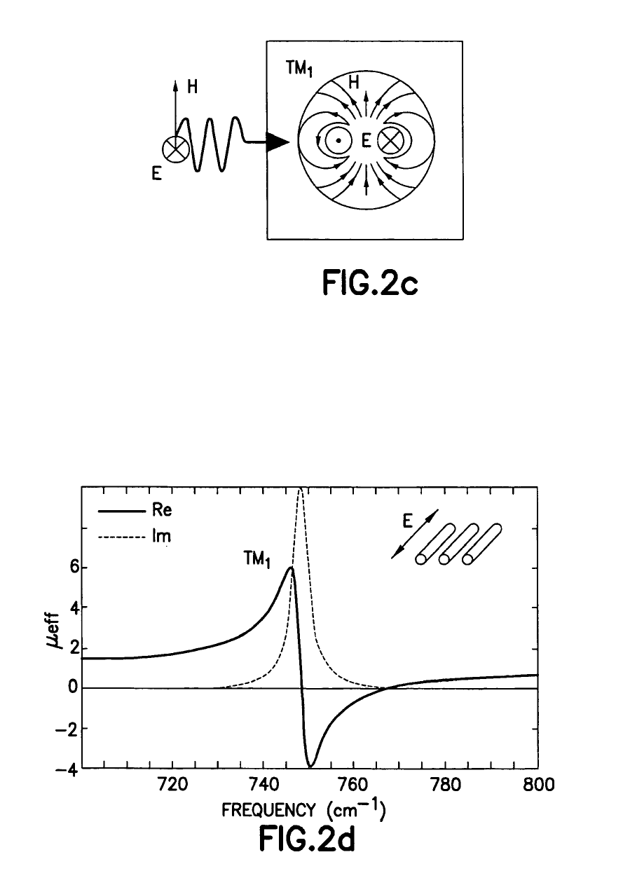

### DETAILED DESCRIPTION

Lanthanide ions such as Cerium, Erbium, Europium, and Neodymium have been employed for years as light emitters in a wide range of devices, including color television sets, fluorescent lighting and solid-state laser systems and fiber amplifiers. Interestingly, the same shielded electronic structure which makes such ions ideal light emitters also makes them ideal quantum mechanical magnetic resonators. Due to the filling rules for electron energy levels, the valence 4f electrons in Lanthanide ions are shielded by complete 5s and 5p orbitals which protect excited electrons from scattering events and provide time for parity-forbidden intra-4f emission. Therefore, the optical transitions of Lanthanide ions offer ultra narrow linewidths even at very high concentrations, i.e., many high-quality, structurally symmetric resonators within a small, subwavelengh volume. Moreover, these multilevel electronic resonators naturally offer integrated gain which may be accessed by either optical or electrical pumping. These facts suggest that rare-earth magnetic dipole transitions could enable a new class of active, easily fabricated, low-loss, isotropic metamaterials based upon optical frequency, quantum magnetic resonances.

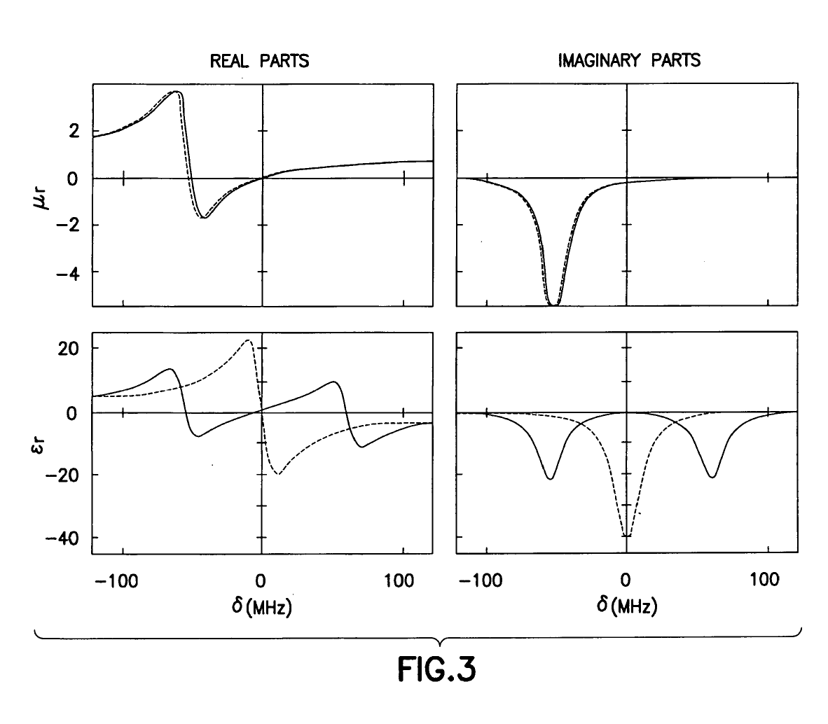

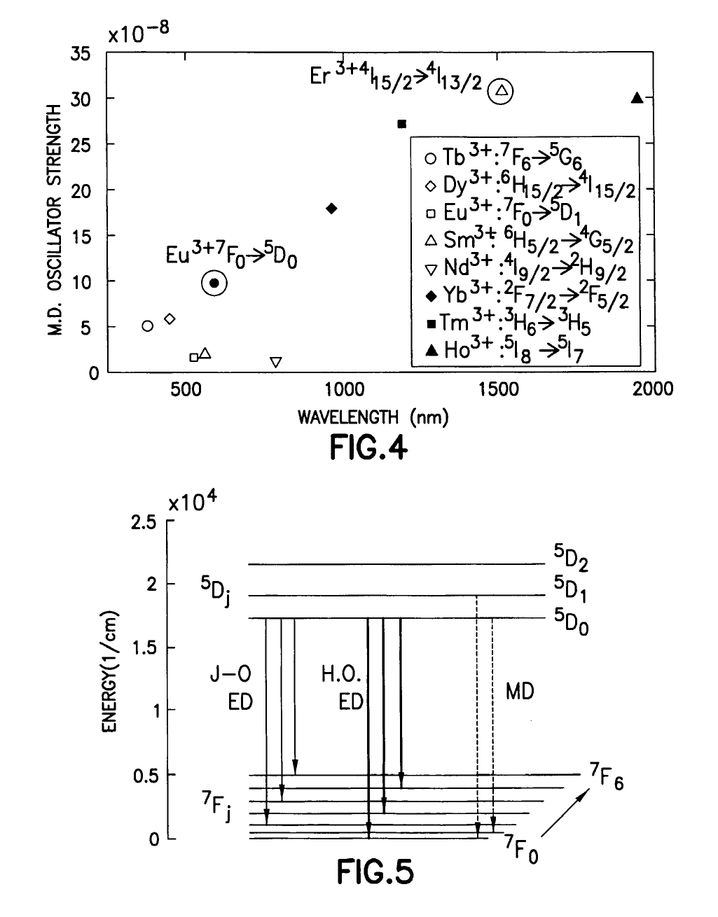

FIG. 4 depicts Lanthanide magnetic dipole transitions in the visible and near-infrared regime.

To appreciate the potential of Lanthanide transitions for optical metamaterials, it is important to note that any Lorentz-like resonance scales linearly with the product of oscillator density n and oscillator strength f. FIG. 4 presents the calculated magnetic dipole oscillator strength for a number of lanthanide ion transitions. These dimensionless values for f_{md} range from 10⁻⁸ to 3×10⁻⁷. Such values may appear small until one notes that the ion density (n) for a lanthanide doped crystal can be on the order of 10²⁶ ions/m³. Thus, the large n f_{md} product can produce significant changes in macroscopic permeability (as shown previously in FIG. 3). An important aspect of atomic optical frequency magnetic activity is in enhancing the oscillator strengths for magnetic dipole transitions. It is now common to engineer optical microcavities and photonic crystals to enhance the strength of electric dipole transitions via the Purcell effect. It is now clear that the transition probability for any absorption/emission process is not only a function of the electronic states of the atom, but also a function of the local optical environment. Researchers have even made progress in studying how nanoscale metallic structures can serve as optical antennas to modify the near-field modes accessible for electric dipole transitions. However, relatively little attention has been paid to the impact of such near-field effects on higher order transitions, and it is often forgotten that Purcell's work specifically discussed the enhancement of magnetic dipole transitions.

The exemplary embodiments of this invention provide novel classes of optically-active composite materials based upon the enhancement of magnetic dipole transitions. In analogy to optical microcavities, optical techniques may be used to modify light-matter interactions to realize optical frequency metamaterials and novel luminescent composites by enhancing the natural magnetic dipole transitions of Lanthanide ions.

These novel luminescent composites have direct application in the areas of fluorescent lighting, solid-state lighting, optical displays, lasers and telecommunications. Moreover, these optical metamaterials have direct application in the areas of nanoscale lithography and imaging by relaxing the considerable fabrication difficulties inherent to superlens and hyperlens—newly developed optical techniques which can overcome the diffraction limit, but require the ability to tune negative refractive indices in space and along curved surfaces. Metamaterials incorporating Lanthanide ions also offer the intrinsic gain necessary to realize amplification in nanoscale optical circuits and lasers.

Selective Enhancement of Magnetic Dipole Transitions

Lanthanide ions provide a model system in which to realize optical enhancements of magnetic dipole transitions. For example, the ⁵D₀→⁷F_{J} transitions for trivalent Europium ions shown in FIG. 5 offer a range of both electric and magnetic dipole transitions for comparative analysis. These transitions are clearly visible in both absorption and emission spectra of Eu-doped crystals and glasses as well as thin polymer films prepared with Europium chelates. Using this model system it can be shown that structuring the local optical environment enables the selective enhancement of the Eu³⁺:⁵D₀→⁷F₁ magnetic dipole transition.

More specifically, FIG. 5 is an energy level diagram for EuF₃ that highlights the optical transitions between the ⁵D_{J} and ⁷F_{J} states. The lines designated as J-O ED (red) and H.O. ED (green) indicate the electric dipole transitions allowed by Judd-Ofelt theory (and higher order Wybourne-Downer and J-Mixing theories). The lines designated as MS indicate the magnetic dipole transitions.

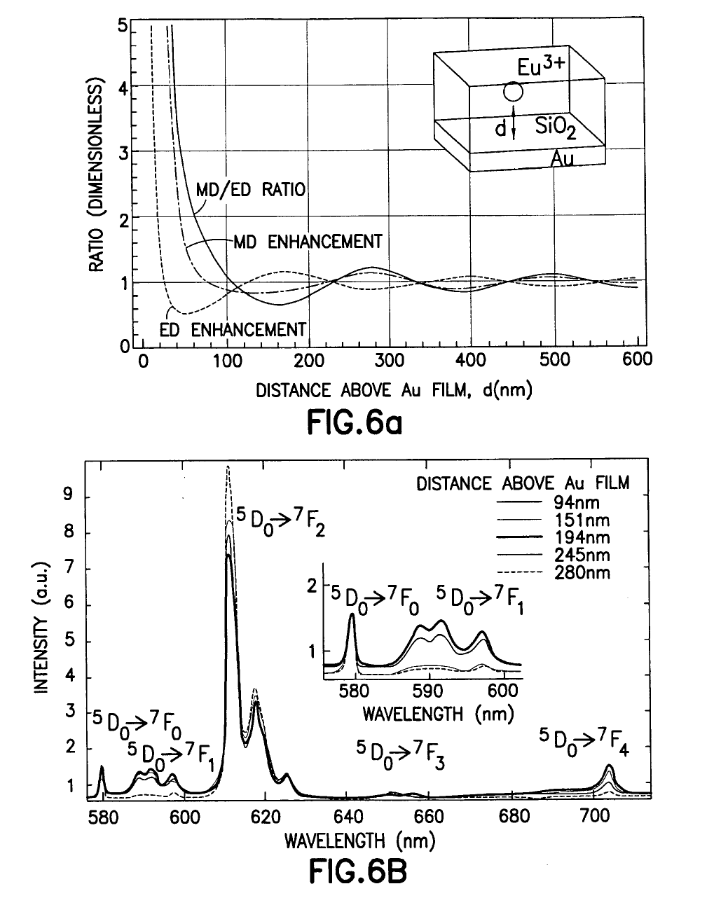

To demonstrate the importance of optical environment, consider the case of a Eu³⁺ emitter located a finite distance from an extended metal surface. FIG. 6(a) shows calculations for the isotropic averages of normalized decay rate for the electric ⁵D₀→⁷F₂ and magnetic ⁵D₀→⁷F₁ dipole transitions. It is clear that proximity to a metal film can modify the ratio of magnetic to electric transitions. While both dipole rates can be enhanced, the relative ratio of this enhancement depends upon the precise distance.

More specifically, FIG. 6(a) shows calculated and FIG. 6(b) shows observed emission enhancement for Eu³⁺ emitters above an extended gold film. In FIG. 6(a) the dashed lines show calculated radiative enhancement factors for the ⁵D₀→⁷F₁ magnetic dipole transition at 594 nm and the ⁵D₀→⁷F₂ electric dipole transitions at 615 nm, while the solid line shows the ratio of magnetic to electric dipole emission. In FIG. 6(b) experimental emission spectra observed from single Europium chelate monolayers as a function of SiO₂ spacer layer thickness is displayed. The inset highlights enhancement of ₅D₀→⁷F₁ magnetic dipole transition for 194 nm and 245 nm thick films.

To confirm this enhancement experimentally, standard thin film deposition techniques were used to prepare samples similar to the inset in FIG. 6(a). Variable thickness SiO₂ spacer layers were fabricated on top of extended gold films, and then Langmuir-Blodgett techniques were used to deposit a single monolayer of Europium Tris(dibenzoylmethane)mono(5-amino-1,10-phenanthroline). FIG. 6(b) shows the photoluminescent emission spectra of this Europium chelate monolayer as a function of SiO₂ film thickness. While the magnetic dipole ⁵D₀→⁷F₁ is barely visible for film thickness of 94, 151, and 280 nm, there is a very marked enhancement of magnetic dipole emission for the 194 and 245 nm thick films.

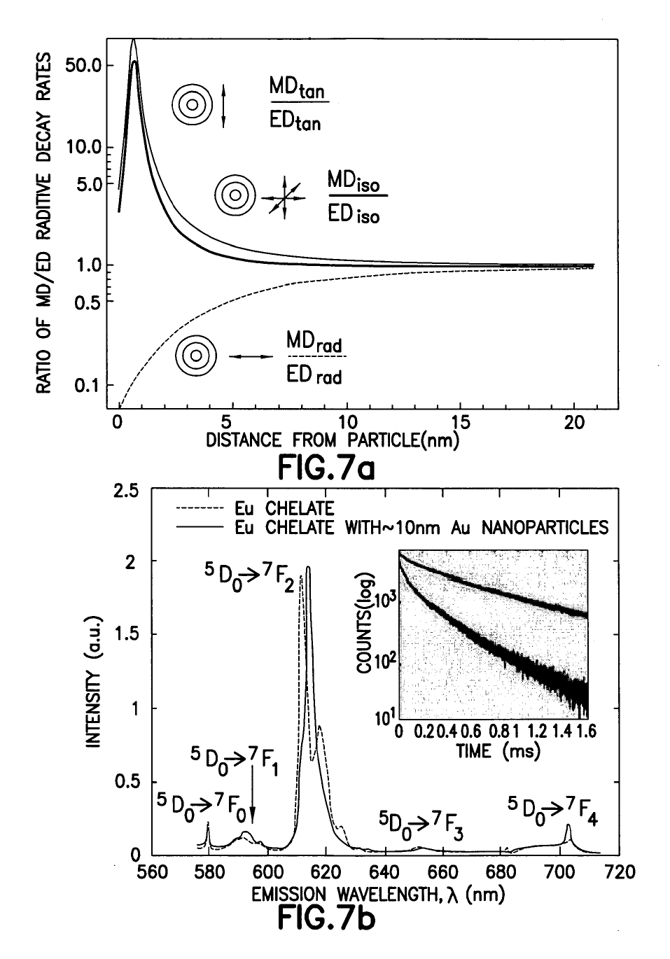

Compared to planar metal interfaces, metal nanoparticles offer the ability to define a greater degree of field heterogeneity within a small volume (via either random composites or structured lattices). Moreover, the effect of even one nanoparticle on the dipole nature can be significant. FIG. 7(a) compares the decay rates for magnetic and electric dipoles as a function of distance and dipole orientation from a 10 nm diameter gold particle. It is well known that the radiative decay of a radially oriented electric dipole can be greatly enhanced, but more interesting for the present purpose is the substantial suppression of radiative decay for a tangentially oriented electric dipole. The suppression of tangential electric dipole emission provides for a dramatic increase in the relative magnetic to electric dipole enhancement. This enhancement of the tangential magnetic dipole dominates when the isotropic average of dipole orientations is considered, which is more accurate for real ionic systems in which one cannot easily control the dipole orientation.

Preliminary experimental results also confirm that the presence of gold nanoparticles can significantly modify the spectra of Eu³⁺. FIG. 7(b) shows the emission spectra and time-resolved photoluminescence for the previously mentioned Europium chelate with and without gold nanoparticles. More specifically, FIG. 7(b), shows the emission spectra and time-resolved photoluminescence for Eu³⁺ Tris(dibenzoylmethane)mono(5-amino-1,10-phenanthroline) with and without Au nanoparticles. Nanoparticle-containing solutions were drop cast on quartz substrates followed by a single monolayer deposition of Europium chelates with the LB technique.

More specifically, FIG. 7(a) shows calculated radiative decay rates near a gold nanoparticle for different dipole orientations, while FIG. 7(b) shows emission spectra and time-resolved photoluminescence (inset) of ⁵D₀ excited state. In FIG. 7(a), for simplicity, the emission wavelength for all emitters is assumed to be 600 nm (ε_{Au}=−7.96+i 2.064). For FIG. 7(b) the data was acquired by pulsed laser excitation (λ=337.1 nm) of chelate monolayers deposited on quartz substrates with and without gold nanoparticles.

From the emission spectra one may observe that the proximity of gold nanoparticles: (1) increases the intensity of the ⁵D₀→⁷F₁ and ⁵D₀→⁷F₄ transitions, (2) decreases the intensity of the ₅D₀→⁷F₀ transition, and (3) shifts the position of the ⁵D₀→⁷F₂ transition. Interestingly, the spectral changes are accompanied by a significant lifetime increase for the excited ⁵D₀ state, as shown by the time-resolved photoluminescence (PL) data. The dominant PL lifetime in the presence of gold nanoparticles (0.497 ms) is more than 2.5 times longer than the lifetime of the chelate monolayer on bare quartz (0.176 ms). Rather than rapidly quenching Eu³⁺ luminescence, it can be realized that the gold nanoparticles suppress the dominant electric dipole mediated decay processes. These results show, by using Eu³⁺ emitters as a case study for magnetic and electric dipole emitters, how one can selectively enhance magnetic dipole emission via perturbations to the local optical environment.

An aspect of the exemplary embodiments of this invention is the development of optical tools to characterize atomic magnetic dipole emission.

Based on the foregoing, it can be appreciated that a goal is the isolation and quantification the ability of metal nanoparticles to selectively enhance magnetic dipole transitions. Note that the data in FIGS. 6 and 7 represent ensemble measurements of many Europium ions. To compare experiment with theory, it is desirable to characterize magnetic dipole enhancement as a function of emitter position and dipole orientation.

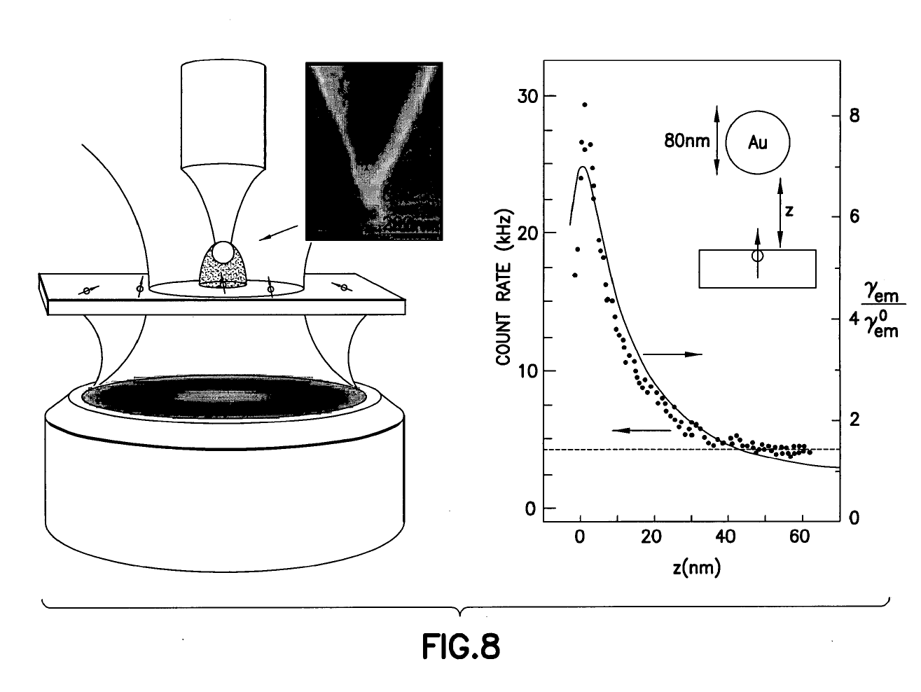

For the electric dipole transitions, robust near-field techniques have been developed to isolate and characterize single molecule emission near metal nanoparticles (see FIG. 8). In single molecule studies, high yield organic molecules are often immobilized in thin polymer films at very low concentrations. This dilution process makes it possible to find isolated single molecules for excitation and characterization. Moreover, encapsulating the molecules within a polymer matrix fixes the molecular dipole orientation. (In organic molecules, the dipole orientation is often determined by the molecule's physical conformation.)

FIG. 8 shows near-field experiments demonstrating modified electric dipole emission near a single gold nanoparticle, from P. Anger et al., Phys. Rev. Lett. 96, 113002 (2006).

In some respects rare-earth ions are ideal subjects for such characterization, and indeed some researchers have been able to image single dipole emission patterns from 3-10 nm Eu³⁺:Y₂O₃ phosphors at room temperature in dilute concentrations. However, the optical properties which make rare-earth phosphors ideal magnetic dipoles for metamaterials (e.g., high doping concentrations and degenerate, isotropic response) also make them difficult to characterize. To a first order, atomic emission is largely degenerate. For example, once a Eu³⁺ ion is excited into the ⁵D₀ state, it may decay into any of the three degenerate ⁷F₁ states (M_{J}=0, ±1) via magnetic dipole emission. Thus, there is no technique to fix the orientation of the emission dipole. Moreover, at even mild doping concentrations it is difficult to excite a small number of ions.

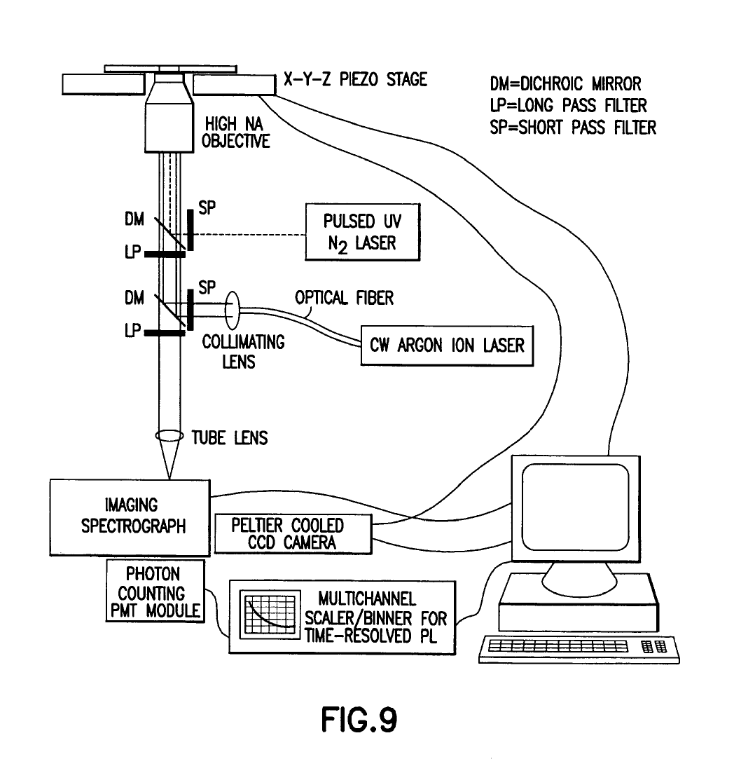

To overcome these challenges, it is within the scope of the embodiments of this invention to provide a near-field scanning microscopy tool which integrates (1) site-selective excitation and (2) polarization-selective detection in order to characterize atomic electric and magnetic dipole emission. FIG. 9 shows a scanning confocal and near field-microscope system that includes a nano precision X-Y-Z piezo stage; an imaging spectrograph incorporated with a photo multiplier tube and a multichannel analyzer for time-resolved measurements; and integrated graphical user interface (GUI) controls from a computer. Not shown in FIG. 9 is a near-field optical probe similar to that depicted in FIG. 8 which can be mounted above the sample, and a TIR-based excitation scheme which uses a two lens system to access the back focal plane of the high N.A. objective.

With specific regard now to site-specific excitation, it can be noted that the parity-forbidden intra-4f optical transitions of Lanthanide ions are generally mediated by the perturbing effects of crystal and ligand fields. The Columbic potential of neighboring species can alter an ion's electronic states. In order to isolate ions within highly doped materials one may exploit the site specific nature of the ⁷F₀→⁵D₀ transition. The precise energy of this line, between the two non-degenerate states, is highly sensitive to local field effects. By tuning a narrow-linewidth dye laser source about this resonance it is possible to selectively excite ions within similar electronic environments.

This selective excitation method has been used to study specific Eu³⁺ dopant sites in crystals such as Yttrium Aluminum Garnet. Varying the excitation wavelength can establish definitive relations between emitters and their local environment, even at room temperature. Note that in the crystal case, the number of possible dopant sites is small. However, for the case of Europium chelates and Eu-doped glasses, there exists a large range of possible local conformations. Thus, by using a narrow excitation source near the ⁷F₀→⁵D₀ transition it becomes possible to both isolate Eu³⁺ ions with the same electronic states and significantly reduce the number of ions observed in any given measurement. Combining this method with standard confocal excitation schemes for single molecules it becomes possible to develop a simple far-field optical technique to provide single ion measurements.

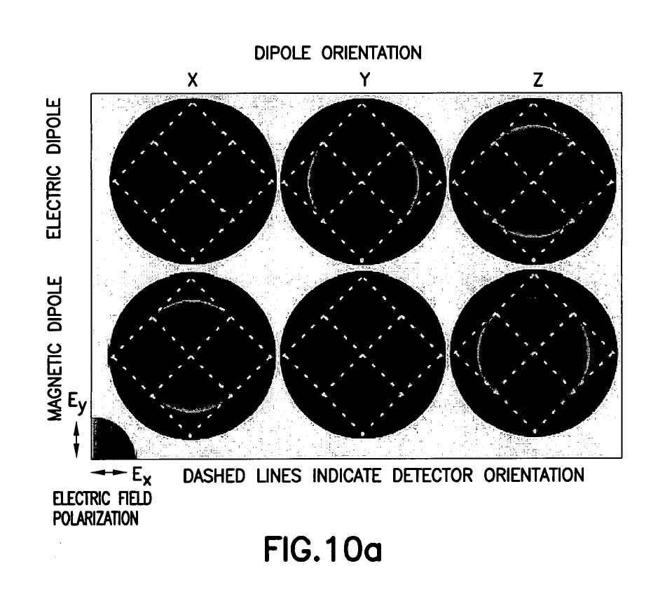

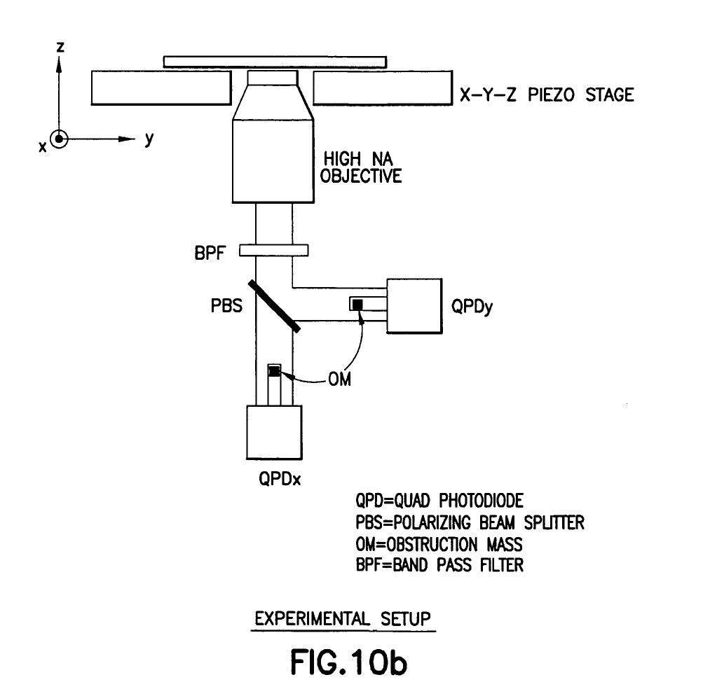

With regard now to polarization-specific detection, and to investigate the role of optical effects, it is important to also definitively characterize the dipole emission processes. FIG. 10 presents, in accordance with an aspect of this invention, an embodiment of a polarization-specific detection scheme designed to quantify the relative contributions of magnetic and electric dipole emission.

The detection scheme depicted in FIG. 10 extends a technique used to characterize electric dipole emission from single molecules. While the radiation patterns of electric and magnetic dipoles are similar, their polarization is distinct. The diagrams in FIG. 10a show dipole emission patterns in the back focal plane of a high numerical aperture objective. By using a polarizing beam splitter cube and quadrant photodetectors, it is possible to distinguish electric and magnetic dipole emission and clearly identify each dipole's orientation.

A further aspect of this invention relates to the design optical composites to enhance magnetic activity.

As was discussed previously, extended metal surfaces and single nanoparticles can clearly enhance magnetic dipole transitions. These simple systems also allow for rigorous comparison of experiments with analytical models. However, such systems represent only first order attempts to enhance magnetic activity. It is thus desirable to design and fabricate optical composites to optimize magnetic dipole transitions and localize magnetic fields, thereby enabling the exploration and exploitation of higher order optical interactions such as local field effects and nonlinear optical processes.

The development of such optical composites uses both contemporary metamaterials designs as well as strongly scattering, disordered systems.

Discussed first is the integration of atomic magnetic dipoles within artificial magnetic resonators. Although the artificial magnetic resonances of metallic nanostructures suffer from the limitations described above, their combination with atomic magnetic emitters may offer considerable advantages. Lanthanide ions may provide a route to substantially increase the total oscillator density within subwavelength volumes, as well as promoting local field effects that augment magnetic activity while providing active electronic species for optically and/or electrically pumped gain to compensate for metallic losses.

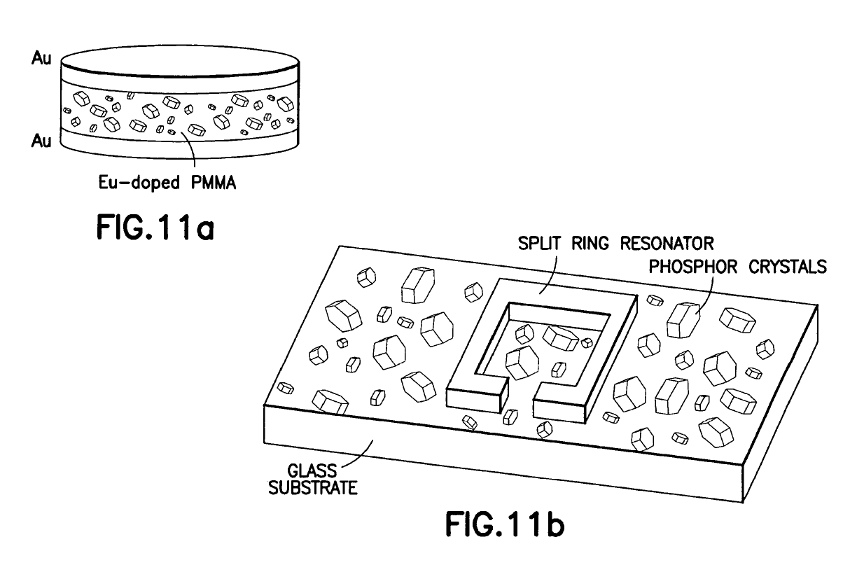

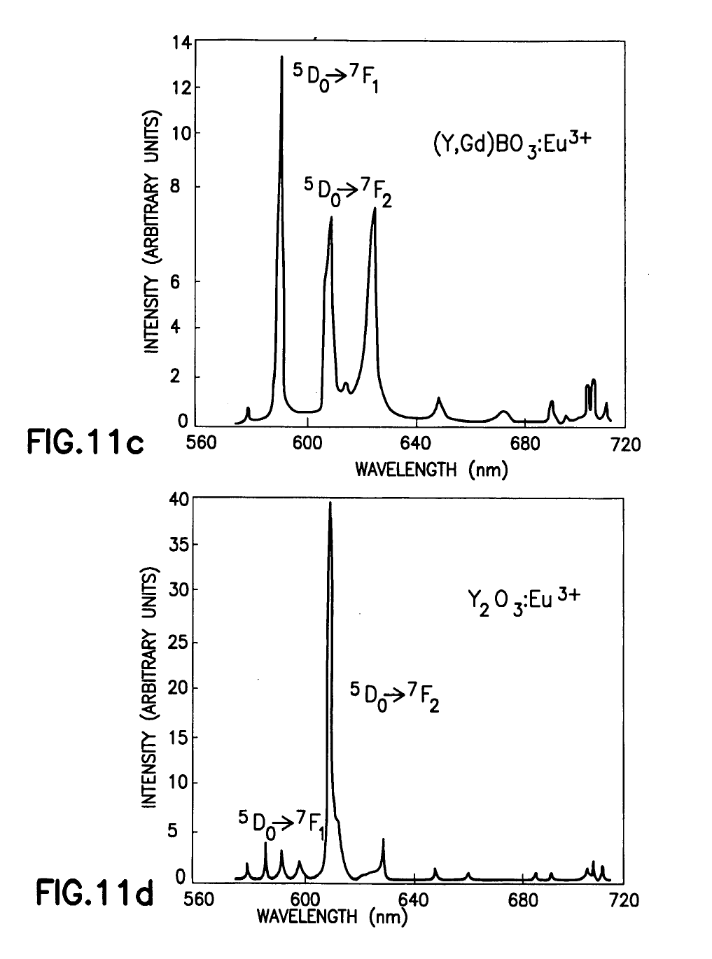

FIG. 11 illustrates two non-limiting embodiments of how lanthanide ions such as Eu³⁺ may be incorporated into conventional metamaterial fabrication processes. In one example stable PMMA films doped with both Europium chelates and Eu-doped phosphors have been prepared. Examples of two phosphor doped spectra are shown in FIG. 11.

More specifically, FIG. 11 depicts integrating atomic and artificial magnetic resonances. Example 11(a) shows PMMA doped with Europium chelates as a spacer layer between paired metallic plates, while FIG. 11(b) shows Lanthanide phosphors dispersed on top of patterned split-ring resonators. FIGS. 11(c) and 11(d) show emission spectra of Europium doped phosphors dispersed in PMMA.

In dilute concentrations, lanthanide phosphors serve as local atomic probes for the artificial magnetic resonance. In high concentrations, magnetic dipole resonances compound enhancements of the local magnetic field.

In a further embodiment Erbium doped PMMA is integrated with split-ring resonators (SRRs) resonant at 1.54 μm. It has been previously demonstrated that magnetic field localization in such SRRs may produce strong second harmonic generation (SHG) in the absence of any traditional nonlinear materials. This metamaterial-enabled SHG process was mediated via the magnetic component of the Lorentz force acting upon metal electrons. In accordance with this further embodiment by introducing Er³⁺ ions it becomes possible to investigate the interaction of atomic and artificial magnetic resonances in this nonlinear process. The strong Er³⁺ magnetic dipole transition at 1.54 μm can be expected to both increase the local magnetic field strength for the metal SHG process and provide an atomistic path to SHG within the localized field volume.

Described now, further in accordance with the embodiments of this invention, is a strongly scattering, disordered ordered systems to enhance magnetic activity.

Given the lithographic nature of artificial magnetic resonances, most metamaterials research has focused on well-defined periodic systems. For designs in the visible regime, the pitch between individual resonators is roughly 200 to 300 nm. In periodic metamaterials, disorder and imperfections are detrimental, and optical properties can be limited by the lowest quality factor components. However, this is not the case for metamaterials enabled by quantum magnetic resonances. For example, within a 200 nm×200 nm×200 nm cube one may have up to a 10⁶ Lanthanide ions with essentially identical magnetic resonances. One advantage to this high oscillator density is that not every resonator must be enhanced to realize a negative index composite; the sheer number of magnetic dipoles means that one can search for statistical enhancements in disordered or weakly ordered systems.

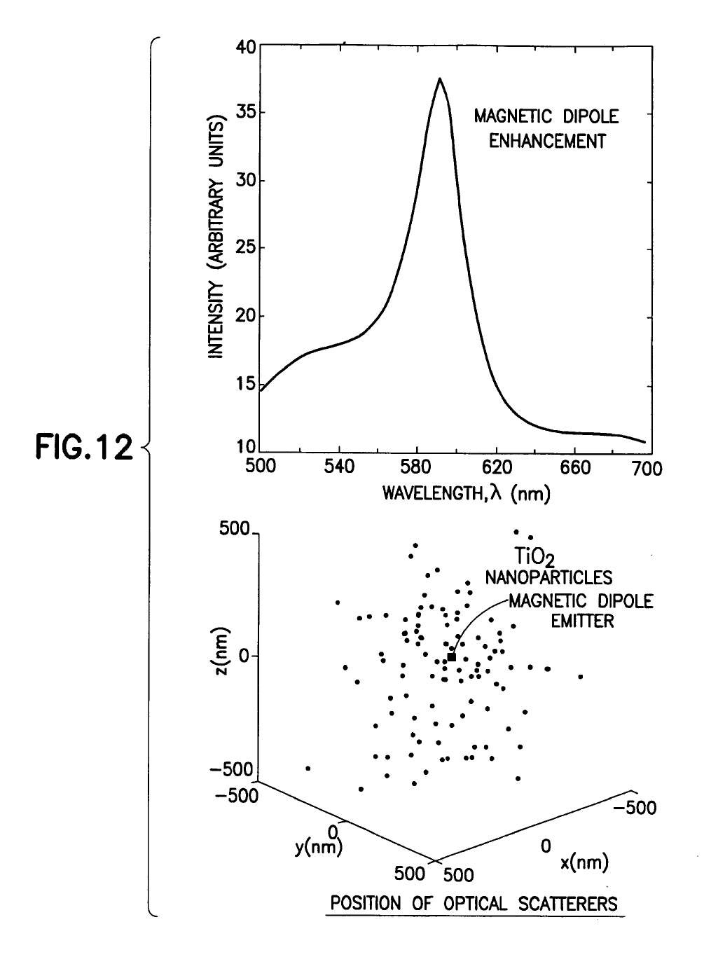

FIG. 12 shows the radiative enhancement factors for a magnetic dipole emitter within a random assembly of TiO₂ nanoparticles. Strong scattering from colloidal suspensions of titania particles was integral to initial demonstrations of random lasing. The large enhancement factor for magnetic transitions suggests that scattering in this system can also strongly enhance magnetic activity.

More specifically, FIG. 12 illustrates the strong magnetic dipole enhancement by a random assembly of TiO₂ nanoparticles. A calculated radiative decay enhancement (normalized to decay within vacuum) for a magnetic dipole emitter located within a suspension of ˜100 titania nanoparticles is shown on the right.

In order to characterize magnetic transitions within such random composites, computational modeling may be used to aid in optimizing a range of parameters (including size of the scattering particles, composition, and concentration).

Discussed now is the fabrication of integrated optical devices to leverage magnetic activity.

It should be appreciated that the ability to produce even small changes in optical frequency permeability may have dramatic implications for photonic devices and optical telecommunications. By introducing another variable into the design process, changes in permeability may enable the development of, as non-limiting examples, novel polarization-selective switches, modulators and isolators. Moreover, if low-loss negative index metamaterials are used then there is enabled the development of deeply subwavelength resonant cavities and optical waveguides. The negative phase velocities (i.e., backwards phase propagation) in negative index materials may also be used for dispersion compensation in long haul optical systems. Previously, researchers have simulated how negative index waveguides could be used to slow and stop light for optical data processing and storage. A first step to realizing any such devices is to characterize permeability changes and negative phase velocities within a practical photonic material.

A distinct advantage that is realized by the use of the exemplary embodiments of this invention is the ease with which practical photonic devices can be fabricated with rare-earth doped materials. Lanthanide-doped glasses have been extensively used in fiber optic amplifiers, and rare-earth doped fibers and preforms are standard, commercially available products. Researchers have also developed techniques to prepare Lanthanide-doped polymeric fibers and planar photonics devices. Thus, there exist robust fabrication methods for development of integrated optical components within both glass and polymer host materials.

Accordingly, an aspect of the exemplary embodiments of this invention is the exploitation of permeability changes and negative refraction in Lanthanide doped optical devices including, as non-limiting examples, passive thin film waveguides, bulk glass prisms, magnifying superlens and optically pumped metamaterial lasers.

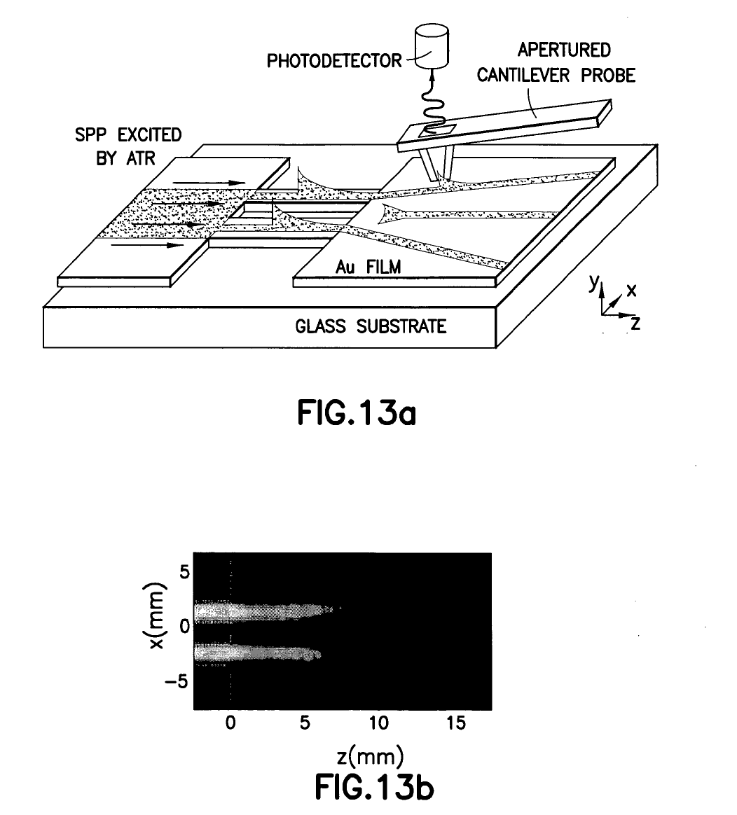

As a demonstration of negative refraction in an Erbium-doped prism, one may tune a narrow-linewidth external cavity diode laser about the 1.54 μm magnetic dipole transition and observe a drastic change in the angle of refraction with the prism. In contradistinction to this bulk effect, optical frequency magnetic resonances that occur in a planar photonic device may be used. One may characterize the propagation of light within planar Lanthanide-doped waveguides and multimode interferometers, and these devices may be fabricated by lithographic patterning of Eu-doped PMMA layers on glass substrates and free-standing Si₃N₄ films. Although the latter structure would not normally support guided modes (given the high refractive index of Silicon Nitride), it can guide light over the narrow frequency regime where significant permeability changes occur in the Eu-doped layer. The optical modes of such waveguides can be directly probed using photon scanning tunneling microscopy techniques, where a near-field optical probe is used to scatter light from the modes. Previously there was constructed a photon-scanning tunneling microscope (PSTM) to probe the propagation, diffraction and interference of surface plasmon modes, as shown in FIG. 13, which depicts (a) a schematic of the PSTM used to characterize surface plasmon waveguides and (b) an experimental near-field image from R. Zia et al., Nature Nanotech. 2, 426-429 (2007). A similar technique may be used characterize negative refractive indices in Lanthanide doped thin films.

With regard to advanced optical devices, such as 3D metamaterial lenses and active metamaterial lasers, in order to construct large scale, three-dimensional metamaterial devices the refractive index should be locally defined in space. In addition, metamaterial designs for superlenses and optical cloaks also require the ability to define curved surfaces. In this regard, Lanthanide-doped materials present a clear advantage to other metamaterials, because standard ion implantation and annealing processes can be used to define the precise doping profile within a variety of glasses and crystals. Moreover, these materials can be milled like standard optical lenses.

Consider, as a non-limiting example, the hyperlens shown in FIG. 14, which illustrates a magnifying optical hyperlens, from Z. Liu et al. Science, 315, 1686 (2007), where (a) shows simulations and (b) experimental images demonstrating subdiffraction resolution with a multilayer metallo-dielectric metamaterial. In this particular device a series of curved metal-dielectric multilayers were used to achieve sub-diffraction limited imaging resolution. a schematic of a metamaterial-enabled laser. However, using a Lanthanide-doped glass it becomes possible to shape such a high resolution lens by three steps: ion implantation, annealing, and milling. Moreover, as the atomic metamaterial forms a more continuous medium, the final lens provides truly graded optical indices.

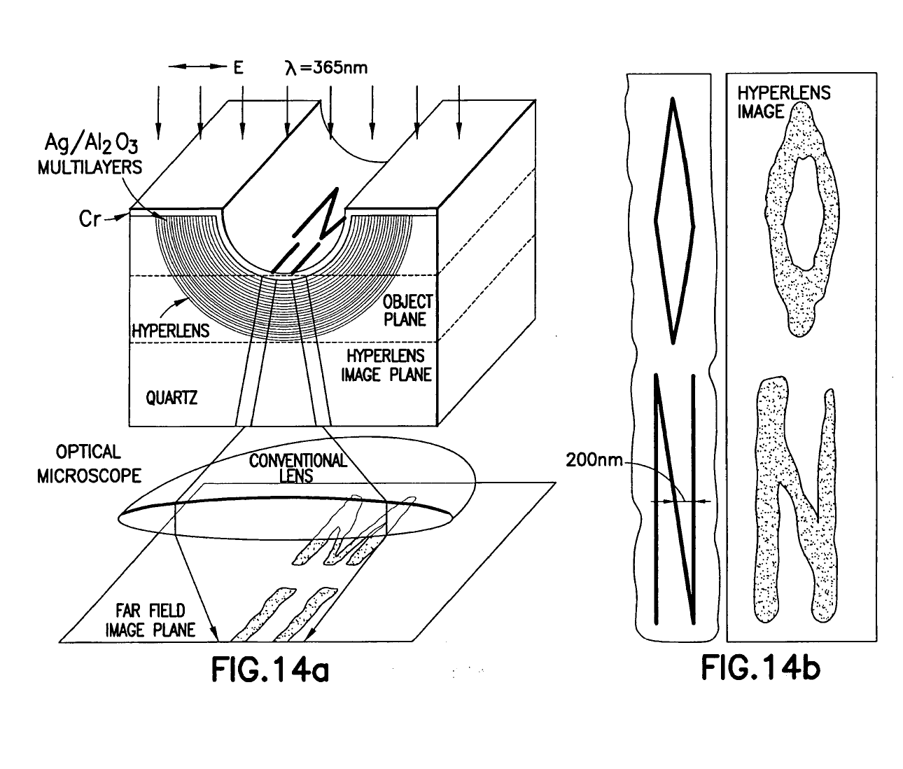

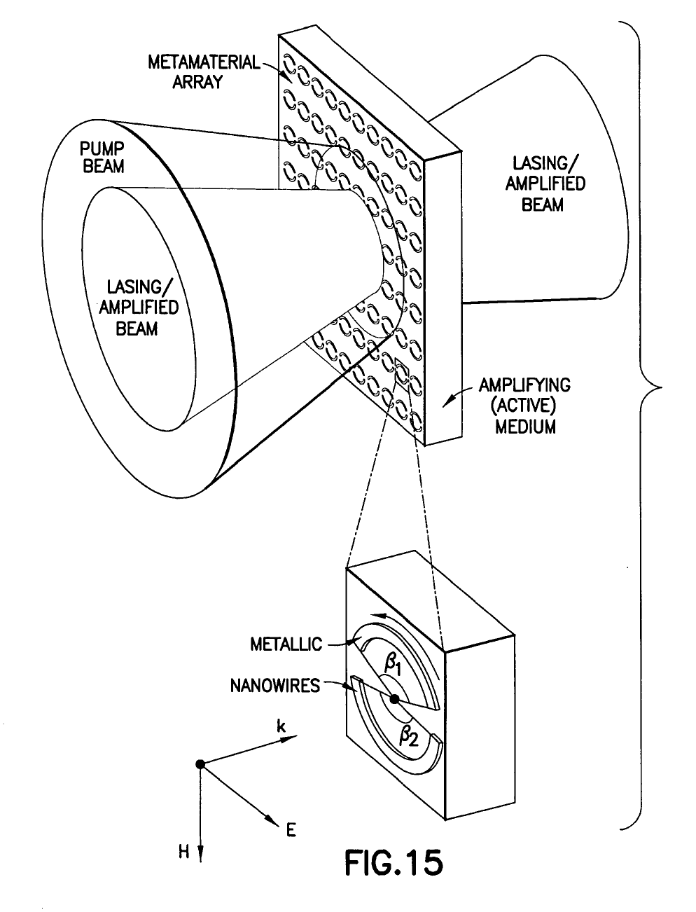

Furthermore, even if certain optical metamaterials cannot be readily achieved using atomic transitions alone, it is clear that the coupling of atomic magnetic resonances and the artificial resonances of metallic metamaterials have clear advantages for photonic devices. Recent designs for optical lasing already call for the integration of amplifying media with metamaterials. For example, FIG. 15 shows a schematic of a metamaterial-enabled laser from N. I. Zheludev et al. Nature Photon. 2, 351 (2008). To optimize radiative decay it is useful to leverage atomic magnetic transitions in the gain media, such that the emission pattern of the local emitters provide maximum overlap with the mode profile of the metallic resonators.

Based on the foregoing it should be clear that by enhancing magnetic dipole transitions there are provided additional pathways by which light can interact with matter. If one imagines any electronic system as a ladder of energy states, then electric dipole allowed transitions connect only a limited number of rungs. If one desires to access all possible states to engineer quantum electronic systems, such as atoms and quantum dots, then control and the enhancement of higher order transitions is needed.

Enhancing higher order transitions is related to the control of metastable states in spectroscopy, single photon sources and optical memory. In single photon sources, quantum dots spend a disproportionate amount of time in dark states and, thus, any ability to promote rapid decay from these metastable states would dramatically increase reliability and repetition rates. Similarly, the ability to store energy in a metastable electronic state and then trigger its radiative decay at a later time is applicable to applications in, for example, all-optical memory and computing.

Further in accordance with the exemplary embodiments of this invention there is provided an all-optical path to enhance forbidden transitions for lanthanide spectroscopy. Rather than perturb the electronic configuration of rare earth emitters with local crystal fields, instead the local optical environment is modified through the introduction of scattering sites. Proximity to gold nanoparticles may be used to selectively modify the emission spectra for, as one example, trivalent europium ions.

More generally, these exemplary embodiments exploit at least in part the ability of metal nanoparticles to enhance magnetic dipole transitions.

As was noted above, lanthanide luminescence has played an important role in spectroscopy and physical chemistry. Excitation and emission spectra have allowed researchers to peer inside the closed 5s²5p⁶ shell of lanthanide ions and probe their characteristic 4fⁿ electrons, while local field effects enable the characterization of the coordination chemistry of such ions in solution. Lanthanide complexes have also been used extensively as luminescent biological probes. Since the intra-4f optical transitions of lanthanide ions are parity-forbidden, emission is generally mediated by the perturbing effects of crystal and ligand fields. One traditional focus of lanthanide spectroscopy has been to quantify and exploit these electronic perturbations with novel ligand and crystal structures.

Studies of the spectra of lanthanide complexes near nanoscale metallic particles have shown that metal nanoparticles can enhance excitation efficiencies and quench fluorescence. Such effects leverage the antenna-like properties of these efficient scatterers to modify the near-field modes accessible for electric dipole transitions. However, relatively little attention has been paid to the impact of such near-field effects on higher order transitions. Indeed, most works on lanthanide spectroscopy specifically assume that magnetic dipole transitions are insensitive to the local environment and may be used as an “internal standard” by which to reference other transitions.

Of particular interest herein are optical perturbations to magnetic dipole transitions. By investigating the ⁵D₀→⁷F_{J} transitions for trivalent Europium ions it can be demonstrated that metal nanoparticles may be used to selectively enhance higher order transitions. The FIG. 5 discussed above shows the energy level diagram for Eu³⁺ and the associated optical emission pathways. Approximately half of the lines are associated with electric dipole transitions that are well described by crystal/ligand field perturbations according to Judd-Ofelt Theory. Inclusion of additional perturbation terms for spin-orbit coupling (as described by Wybourne-Downer Theory) and J-mixing can account for most remaining lines. However, the dominant emission processes for the ⁵D₀→⁷F₁ is a magnetic dipole transition, which does not require perturbation from the crystal field. (The magnetic dipole transition is mediated by spin-orbit coupling which weakens the ΔS selection rule between Russell-Saunders states.) Thus, Eu³⁺ is a particularly useful system with which to explain the comparative impact of optical perturbations on electric and magnetic transitions.

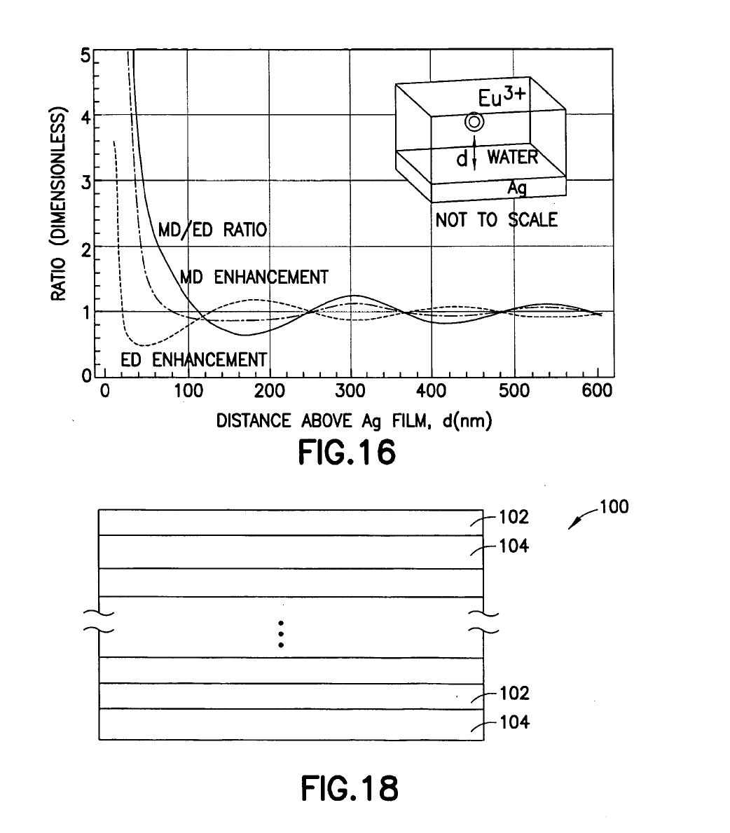

To demonstrate the importance of optical environment, consider an emitter above an extended metal film. FIG. 16, which is similar in some respects to FIG. 6(a) discussed above, shows the relative optical enhancement of the radiative decay rates for the ⁵D₀→⁷F₁ and ₅D₀→⁷F₂ transitions of a Eu³⁺ ion located a finite distance from a silver film. Note that in FIG. 16 Ag is the metal, and water is the spacer, as opposed to SiO₂ in FIG. 6. Assuming that these are magnetic and electric dipole transitions respectively, the relative enhancement factors as compared to emission into a homogeneous environment can be calculated. From FIG. 16, it is clear that proximity to a metal film can modify the ratio of magnetic to electric transitions. While both dipole rates can be enhanced, the relative ratio of this enhancement depends upon the precise distance and diverges rapidly as the distance is decreased. Even at a relatively large distance of 50 nm, the magnetic dipole enhancement is 5 times stronger than the electric dipole enhancement.

As was noted above with respect to FIG. 6, as compared to planar metal interfaces metal nanoparticles offer the ability to define a greater degree of field heterogeneity inside a small volume (via either random composites or structured lattices). The effect of even one nanoparticle on the dipole nature can be significant.

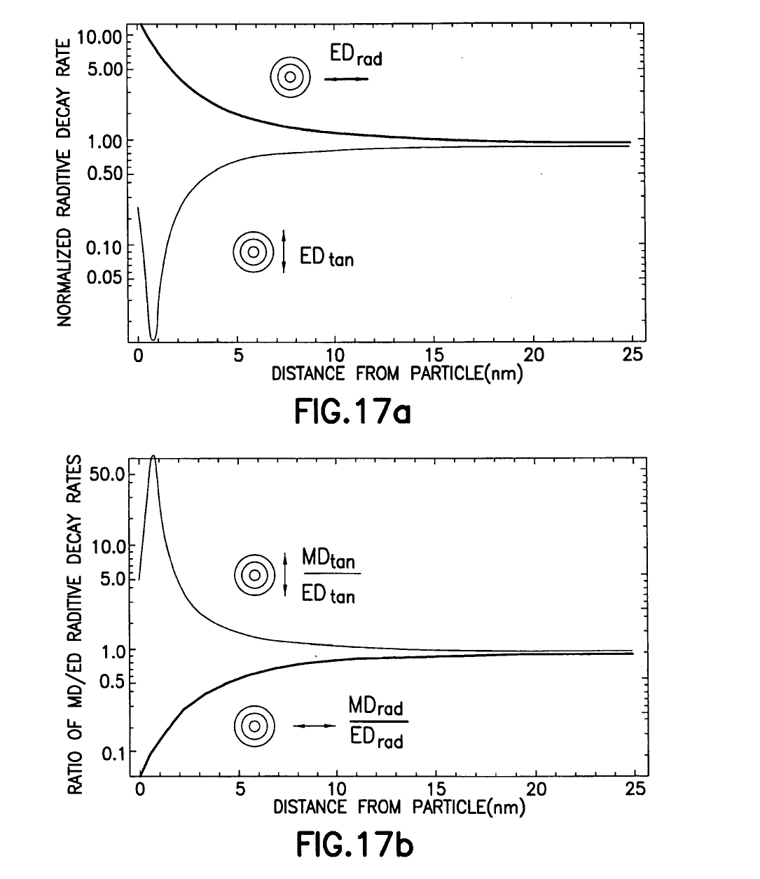

FIG. 17 shows radiative decay rates near a gold nanoparticle for different dipole orientations. For simplicity, emission wavelength for all emitters is assumed to be 600 nm (ε_{Au}=−7.96+i 2.064). FIG. 17(a) shows the normalized radiative decay rates for an electric dipole emitter as a function of distance and dipole orientation from a 10 nm diameter Au particle. It is known that the radiative decay of a radially oriented electric dipole oriented can be greatly enhanced, but more germane to an understanding this invention is the substantial suppression of radiative decay for a tangentially oriented electric dipole. FIG. 17(b) compares the decay rates for magnetic and electric dipoles of a given orientation. The suppression of tangential electric dipole emission provides for a dramatic increase in the relative magnetic to electric dipole enhancement. Of course, for the multilevel Eu³⁺, the ultimate emission process will be a complicated function of many possible decay paths of differing polarization and orientation. However, it should be appreciated that metallic nanoparticles can be used to selectively enhance magnetic dipole transitions.

As was noted above with respect to FIG. 7(b), from the emission spectra one can observe that the proximity of Au nanoparticles: (1) increases the intensity of the ⁵D₀→⁷F₁ and ⁵D₀→⁷F₄ transitions, (2) decreases the intensity of the ⁵D₀→⁷F₀ transition, and (3) shifts the position of the ⁵D₀→⁷F₂ transition. These spectral changes are accompanied by a significant lifetime increase for the excited ⁵D₀ state.

While some of the observed behavior could be associated with shifts in ligand positions (e.g. reduced Stark splitting of the ⁷F₂ states), the observed spectral changes are also consistent with the polarization and orientation dependent radiative decay rates shown in FIG. 17. Moreover, it is possible that some of the increased intensity for the ⁵D₀→⁷F₂ and ⁵D₀→⁷F₄ could be associated with magnetic, rather than electric, dipole transitions via J-mixing.

It is within the scope of these exemplary embodiments to deposit monolayers of Europium chelates and fatty acids, and to exploit Langmuir-Blodgett (LB) techniques to precisely control the distance of Eu³⁺ from the metal nanoparticles. The fatty acid layers may be used as dielectric spacers. LB techniques may also be employed to deposit close-packed monolayers of Au nanoparticles. Integrating LB deposition of the emitter, spacers, and scatterers enables fabrication of a broad range of potential devices.

In general, providing an optical technique to enhance forbidden emission processes has broad implications. At a fundamental level, such optical perturbations may allow for spectroscopic characterization of previously inaccessible electronic states or states which before could only be observed in highly perturbed electronic environments. Moreover, a better understanding of near-field optical effects may dramatically increase the sensitivity of spectroscopy characterization; in this regard one need only consider the analytical utility of surface-enhanced Raman spectroscopy. At a more practical level, optical perturbations may provide another tool to design and engineer specific emission properties. In the past, electronic perturbations provided by ligand field effects have enabled the development of a broad range of technologies from the rare-earth phosphors in color television and fluorescent lighting to the Erbium-doped fiber amplifier and the solid-state Neodymium:YAG laser. If optical perturbations enable just a small fraction of similar developments, then the impact would be considerable.

In accordance with the exemplary embodiments of this invention the optical scattering agent may be comprised of nanoparticles, which may be metallic (e.g., Au, Ag) or some other material, such as an oxide (e.g., TiO₂), an insulator, a semiconductor, or a mixture of various types of nanoparticles. The scattering particles are effective at optical wavelengths from ultra-violet to near-infra-red. The optical scattering agent may be embodied as the nanoparticles, or as a structured surface (e.g., a patterned grating), and/or as an extended planar (or curved) surface, as non-limiting examples. The optical scatterers introduce a perturbation of electromagnetic fields that allows for the introduction of near-field evanescent waves near to the surface of these objects. These evanescent waves are capable of providing for much larger spatial variations of the optical field as compared to free space. Moreover, the optical scatterers redirect far-field propagating waves and allow for interference effects. Control of the optical scattering leverages one or more of these effects to provide local enhancement or suppression of different multi-polar optical transitions (e.g., enhancement of magnetic dipole transitions and/or suppression of electric dipole transitions). An exemplary and approximate ion to nanoparticle concentration ratio may be in the range of about 10 to about 10×10⁶ Lanthanide ions per scattering nanoparticle.

The exemplary embodiments of this invention bring a rare earth phosphor and optical scatterers into close proximity such that the optical perturbation introduced by the scatterers operates to tune the absorption and/or the emission spectrum of the phosphor by selectively enhancing or suppressing various magnetic and electric dipole transitions. For example, a mixture of 5 nm-10 nm Au nanoparticles and trivalent Europium chelates in a polymer PMMS matrix enhances the magnetic dipole transition at 590 nm and suppresses the dominant electric dipole transition at 612 nm to effectively blue-shift the emission spectra.

The particles sizes may be uniform or non-uniform. An exemplary range of particle sizes is about 5 nm to about 50 nm, or smaller. The Lanthanide ions may be selected from any one or more of Ce, Pr, Nd, Pm, Sm, Eu, Gd, Tb, Dy, Ho, Er, Tm, Yb, and Lu. For example, the Lanthanide ions may be one or more of a trivalent or a divalent species of Cerium, Neodymium, Samarium, Europium and Erbium. Note that the electronic structures of excited Lanthanide ions allow for relaxation through both electric dipole and magnetic dipole transitions and, thus, the emission/absorption spectra of these ions includes both magnetic and electric dipole lines.

The Lanthanide ion(s) and scatterers may be used in combination with suitable substrates, such as dielectric substrates such as polymeric (e.g., PMMA) substrates, or glass substrates, or quartz substrates as non-limiting examples. The Lanthanide ion(s) and scatterers may be used in combination with, and may be embedded in, a suitable solid or liquid matrix. In either case the optical perturbation of the scatterers tunes the macroscopic permittivity and permeability of the composite material. The matrix is selected to be substantially transparent to wavelengths of light of interest. These embodiments exploit the magnetic and electric transitions that occur with rare earth phosphors, which act as microscopic magnetizable and polarizable elements. The scatterer-induced optical perturbations tunes both the absolute and the relative magnitudes of these elements. For example, an Au nanoparticle and a Europium chelate mixture in a PMMA matrix may serve as a luminescent material with enhanced emission from the 590 nm magnetic dipole transition. Moreover, the existence of different magnetic and electric lines in close spectral proximity can provide materials with negative effective indices.

Referring to FIG. 18, a multi-layered structure 100 may be comprised of alternating rare earth phosphor and scattering nanoparticle containing layers 102 and dielectric layers 104. Note that the selected rare earth phosphor and/or optical scattering agent in one layer may or may not be the same as the selected rare earth phosphor and/or optical scattering agent in another layer of the multi-layered structure. This particular type of multi-layered structure 100 maybe particularly useful in constructing, for example, a light emitter, such as a light emitting diode type of device.

Note further that the wavelength of light emitted in rare earth phosphor and scattering nanoparticle containing layers 102 may be the same in each layer 102, or the wavelength may be different from one layer as compared to another layer 102. Further in this regard, light emitted from one layer may interact the rare earth phosphor/scattering nanoparticles in another layer.

The Lanthanide ions with scattering particles may be embodied in a matrix, such as a polymeric matrix, or disposed in a thick film or a thin film coating that may be part of, for example, a light source or a display screen. The Lanthanide ions with scattering particles selectively enhance the Lanthanide ion intra-4f transitions of interest to tune the spectral distribution.

The exemplary embodiments of this invention further provide for a mixture of rare earth phosphors and optical scatterers as a spectra downconverting coating on a light source or a display screen (as two non-limiting examples). For example, a thin film of Au nanoparticles and Europium chelates may be used to absorb ultraviolet light from a light emitting source, such as an LED, and re-emit visible green, yellow, orange or red light depending on the mixture.

The exemplary embodiments of the invention may be used to improve the performance of light sources and light receivers/detectors. The exemplary embodiments of the invention may be used to improve the performance of devices such as those included in solid-state lighting technologies, such as LEDs, by improving spectral output and/or quantum efficiency. These exemplary embodiments may also be used to improve the performance of fluorescent lighting technologies by improving the spectral output of phosphor coatings on fluorescent lamps. These exemplary embodiments may also be used to improve the performance of telecommunication amplifiers and modulators by tuning the gain spectrum and/or the dispersion properties of rare earth doped fibers.

Further, the optical composite materials described herein may facilitate the fabrication of isotropic magnetically active materials in the visible and near-infrared regions, enabling significant improvements in optical imaging, lithography, and sensing, as well as the development of new photonics devices for optical communications.

It has been shown that optical scatterers and thin films can be used to selectively enhance magnetic dipole transitions. Experimental results show that metal nanoparticle and metal films can selectively enhance the luminescence from magnetic dipole transitions in, for example, trivalent Europium. Additionally, it has been shown that dielectric scatterers, such as TiO₂ nanoparticles, can also enhance magnetic dipole transitions. These exemplary embodiments clearly illustrate how optical effects can be used to enhance magnetic dipole transitions, in contrast to claims in the literature to the contrary.

Various modifications and adaptations may become apparent to those skilled in the relevant arts in view of the foregoing description, when read in conjunction with the accompanying drawings and the appended claims. For example, the several non-limiting examples described above of specific rare earth compositions, scattering agent compositions, matrix and substrate material compositions, sizes of scattering agent nanoparticles and the like are not to be construed as limiting in any respect the use and practice of the exemplary embodiments of this invention.

Further, it should be noted that certain specific transition labels described above (e.g. the ⁵D₀→⁷F₁ transition in Eu³⁺) applies to trivalent Europium and, in other ions, the transitions will be different. However, these exemplary embodiments are broadly applicable to enhance any magnetic dipole transitions.

Furthermore, some of the features of the examples of this invention may be used to advantage without the corresponding use of other features. As such, the foregoing description should be considered as merely illustrative of the principles, teachings, examples and exemplary embodiments of this invention, and not in limitation thereof.

What is claimed is:

1. An optically active material comprising a mixture of Lanthanide ions and an optical scattering agent.

2. The optically active material as in claim 1, where the optical scattering agent is comprised of nanoparticles comprised of a metal.

3. The optically active material as in claim 1, where the optical scattering agent is comprised of nanoparticles comprised of a semiconductor.

4. The optically active material as in claim 1, where the optical scattering agent is comprised of nanoparticles comprised of an insulator.

5. The optically active material of claim 1, where the optical scattering agent is comprised of one of a planar or a curved surface.

6. The optically active material of claim 5, where the surface is patterned.

7. The optically active material as in claim 1, where the optical scattering agent provides a local enhancement or a suppression of multipolar optical transitions.

8. The optically active material as in claim 1, where the optical scattering agent provides at least one of an enhancement of magnetic dipole transitions and suppression of electric dipole transitions.

9. The optically active material as in claim 1, where said mixture of Lanthanide ions and optical scattering agent are embedded in a matrix.

10. The optically active material as in claim 9, where said matrix is substantially transparent to wavelengths of light of interest.

11. The optically active material as in claim 9, where said matrix is comprised of a polymer or a glass.

12. The optically active material as in claim 1, where said mixture of Lanthanide ions and said optical scattering agent are disposed as a layer upon a substrate.

13. The optically active material as in claim 1, where said mixture of Lanthanide ions and said optical scattering agent are disposed as an optically active first layer upon a dielectric second layer.

14. The optically active material as in claim 13, where there is a plurality of first and second layers disposed one upon another in a multi-layered structure.

15. The optically active material of claim 1, where said Lanthanide ions are in the form of a chelate, and where said optical scattering agent is comprised of gold nanoparticles.

16. The optically active material of claim 1, where said Lanthanide ions are in the form of a chelate, and where said optical scattering agent is comprised of TiO₂.

17. The optically active material of claim 1, where the optical scattering agent is selected to interact with said Lanthanide ions so as to increase the intensity of ⁵D₀→⁷F₁ Eu³⁺ transition.

18. The optically active material of claim 1, embodied in a light source.

19. The optically active material of claim 1, embodied in a light receiver.

20. The optically active material of claim 1, embodied in an optical fiber.

21. The optically active material of claim 1, where the optical scattering agent is selected to enhance magnetic dipole transitions from Lanthanide ions so as to at least one of modify emission spectra and tune an effective permeability and permittivity.
